(19) United States
(12) Patent Application Publication
(10) Pub. No.: US 2012/0285088 A1
(43) Pub. Date: Nov. 15, 2012

(54) SAFETY SYSTEM FOR A DOOR OPENER

(76) Inventor: Robert Peter Nolte, Affton, MO (US)

(21) Appl. No.: 13/106,074

(22) Filed: May 12, 2011

(51) Int. Cl. E05F 15/20

(52) U.S. Cl. 49/31

(57) ABSTRACT

A noxious gas detector is provided that is installed internally within at least one of a motor configured to move a door of an enclosure between an open position and a closed position or a control panel for operating the motor. The detector is in communication with a circuit of at least one of the motor or the control panel. The detector is configured to detect noxious gas within the enclosure. The detector is configured to send a signal to the circuit to move the door into the open position when a predetermined level of noxious gas is exceeded.

### BACKGROUND OF THE INVENTION

The subject matter described herein relates generally to a safety system, and more particularly, to a safety system for a door opener.

Garages generally include a door having a motorized opener. The door is mechanically coupled to a motor that is configured to move the door between an open position and a closed position. The motor is typically activated by a control or remote device having a button that when activated instructs the motor to open or close the door. Some motorized openers include circuitry having optical sensors. The optical sensors direct a beam across an opening of the door. If the beam is broken, the motor may automatically move the door into the open position. Accordingly, existing door openers include safety features (in the form of the optical sensors) to prevent the door from closing on an individual, automobile, or other object.

However, conventional garage door openers are not without their disadvantages. In particular, materials that produce noxious gases are often stored in garages or enclosed spaces having a motorized door opener. For example, an automobile left running in an enclosed space will produce poisonous carbon monoxide. Additionally, an automobile equipped with a remote starter may become accidentally started while the automobile is parked in a closed garage. As another example, gasoline, fertilizer, or the like may be stored in a garage and potentially produce dangerous gases. Moreover, manufacturing plants and/or industrial plants may utilize and/or store chemicals that may produce noxious gases.

Currently, motorized door openers are not configured to respond to the presence of noxious gases. Accordingly, if the gases accumulate in a garage or other enclosed space, the gases may reach dangerous levels that could result in injury, illness, or even death.

A need remains for a door opener that is configured to respond to dangerous conditions, for example, the presence of noxious gases.

### SUMMARY OF THE INVENTION

In one embodiment, a noxious gas detector is provided that is installed internally within at least one of a motor configured to move a door of an enclosure between an open position and a closed position or a control panel for operating the motor. The detector is in communication with a circuit of at least one of the motor or the control panel. The detector is configured to detect noxious gas within the enclosure. The detector is configured to send a signal to the circuit to move the door into the open position when a predetermined level of noxious gas is exceeded.

In another embodiment, a noxious gas detector is provided that is in communication with at least one of a motor configured to move a door of an enclosure between an open position and a closed position or a control panel configured to operate the motor. The detector is in communication with a circuit of at least one of the motor or the control panel. The detector is configured to detect noxious gas within the enclosure. The detector is configured to send a signal to the circuit to move the door into the open position when a predetermined level of noxious gas is exceeded. The detector is in communication with an alert system positioned outside of the enclosure so that the alert system is activated when the predetermined level of noxious gas is exceeded.

In another embodiment, a circuit for operating a door is provided. The circuit includes a signal path in communication with a door opener configured to move a door of an enclosure between an open position and a closed position. The door opener is configured to move the door to the open position if the signal path is broken. A detector is provided for detecting noxious gas within the enclosure. The detector is configured to break the signal path when a predetermined level of noxious gas is exceeded so that the door moves to the open position.

### BRIEF DESCRIPTION OF THE DRAWINGS

The presently disclosed subject matter will be better understood from reading the following description of non-limiting embodiments, with reference to the attached drawings, wherein below:

FIG. 1 is a schematic view of an enclosure having a safety system formed in accordance with an embodiment.

FIG. 2 is a bottom perspective view of a motor formed in accordance with an embodiment.

FIG. 3 is a front view of a control panel formed in accordance with an embodiment.

FIG. 4 is a schematic view of an enclosure having a safety system formed in accordance with another embodiment.

FIG. 5 is a circuit diagram of a safety system formed in accordance with an embodiment.

FIG. 6 is a schematic diagram of a building having a safety system formed in accordance with an embodiment.

FIG. 7 is a schematic diagram of a safety system formed in accordance with an embodiment and having a remote alert system formed in accordance with an embodiment.

### DETAILED DESCRIPTION OF THE INVENTION

The foregoing summary, as well as the following detailed description of certain embodiments will be better understood when read in conjunction with the appended drawings. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Various embodiments provide a safety system that is configured to detect the presence of noxious gases within an enclosed space. In particular, a detector, for example, a carbon monoxide detector, is provided within the safety system. The detector may be formed integrally with the safety system or configured to be retrofit into existing safety systems. Upon the detection of a predetermined level of noxious gases, the detector controls a motor of the safety system to open the door thereof, thereby ventilating the enclosed space. In some embodiments, the safety system may include an alert system to provide a visual and/or audible alert that the predetermined level of noxious gases has been detected.

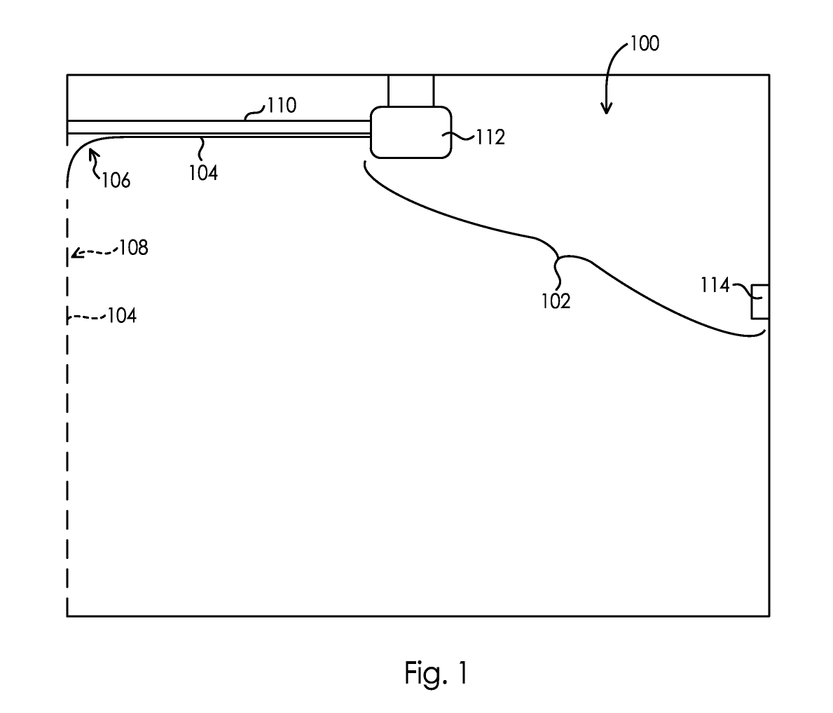

FIG. 1 is a schematic view of an enclosure 100 having a safety system 102 formed in accordance with an embodiment. In an exemplary embodiment, the enclosure 100 is a garage, for example, an attached garage or a detached garage for a residence. The residence may be a single family home or a multi home residence such as an apartment complex, town home, or condominium. In another embodiment, the enclosure 100 may be part of a commercial, industrial or manufacturing facility, for example, a manufacturing plant or warehouse. The enclosure 100 may be used to park automobiles that produce noxious gas in the form of carbon monoxide. The enclosure 100 may also house common sources of carbon monoxide, for example, open flames, space heaters, water heaters, or blocked chimneys. The enclosure 100 may also be used to store gasoline, chemicals, fertilizer, or other substances that produce noxious gas. As used herein, noxious gas refers to any gas, fumes, or smoke that may be potentially dangerous, for example, cause sickness, disease, and/or death. Elevated levels of noxious gas may be dangerous to humans and/or animals depending on the amount of noxious gas present and/or a length of exposure to the noxious gas. Smaller concentrations of noxious gas can be harmful over longer periods of time while increasing concentrations require diminishing exposure times to be harmful.

The enclosure 100 includes a door 104 that is moveable between an open position 106 and a closed position 108 (illustrated by the dashed lines). In the illustrated embodiment, the door 104 is a standard garage door that opens by being moved up and down or away from the enclosure 100. Alternatively, the door 104 may be any type of door. The safety system 102 includes an actuating member 110 that moves the door 104 between the open position 106 and the closed position 108. The actuating member 110 may be a chain-link system (as illustrated), a hydraulic system, a lever, a motorized arm, or the like. A motor 112 is coupled to the actuating member 110. The motor 112 drives the actuating member 110 to move the door 104 between the open position 106 and the closed position 108. A control panel 114 is electrically coupled to the motor 112 to activate the motor 112. In one embodiment, the control panel 114 is in wireless communication with the motor 112.

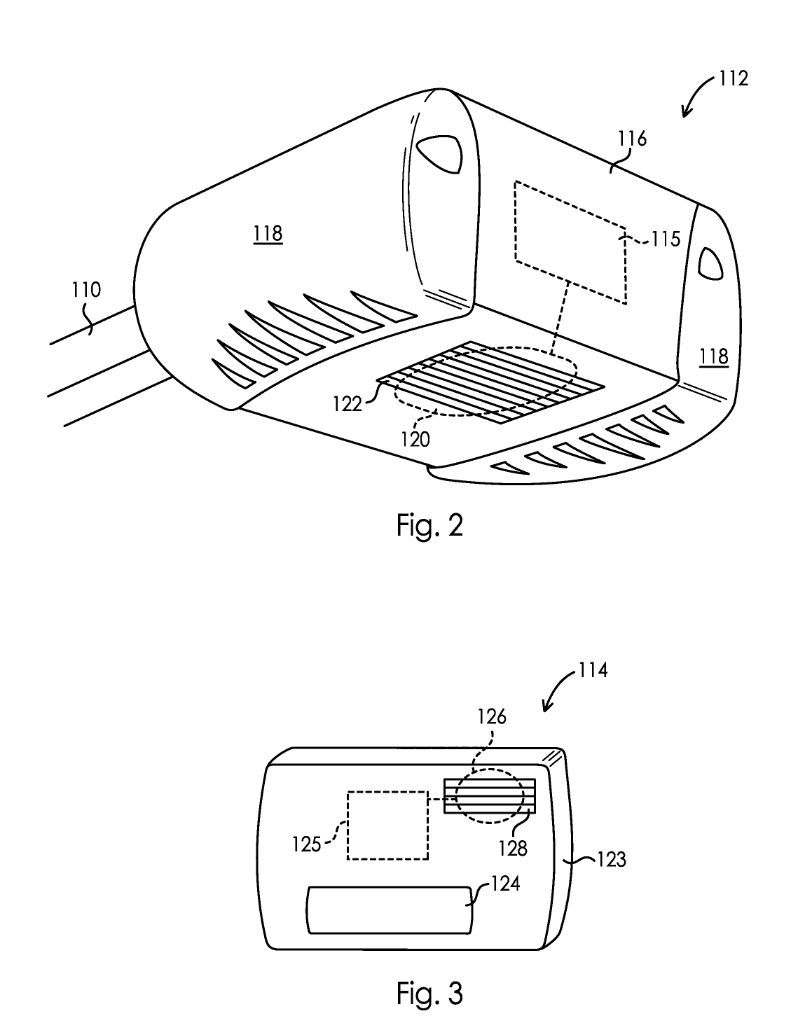

FIG. 2 is a bottom perspective view of a motor 112 formed in accordance with an embodiment. The motor 112 may be configured to be installed to the ceiling of the enclosure 100 (shown in FIG. 1). The actuating member 110 extends from the motor 112 toward to the door 104 (shown in FIG. 1). The actuating member 110 is joined to the door 104. The motor 112 includes a body 116 that houses the mechanical components of the motor 112. The mechanical components are configured to drive the actuating member 110. In the illustrated embodiment, the motor 112 includes lighting devices 118. The lighting devices 118 are positioned on each side of the body 116. As will be appreciated, lighting devices 118 may be joined to any portion of the body 116. The lighting devices 118 are powered by the motor 112. Alternatively, the lighting devices 118 may be powered by the control panel 114 (shown in FIG. 1) or may be independently powered.

A detector 120 is installed internally within the body 116. Optionally, the detector 120 may be installed on an exterior of the body 116. The detector 120 is configured to detect noxious gases within the enclosure 100. For example, the detector 120 may be a carbon monoxide detector. The carbon monoxide detector measures carbon monoxide levels over time and activates the motor 112 to open the door 104 before dangerous levels of carbon monoxide accumulate within the enclosure 100, thereby giving adequate warning and time to safely ventilate or evacuate the enclosure 100. The detector 120 may be activated at concentrations of carbon monoxide above 100 parts per million. In other embodiments, the detector 120 may be activated at concentrations of carbon monoxide above 400 parts per million. The detector 120 may be configured to activate at any concentration of carbon monoxide that may be dangerous to humans and/or animals, while preventing false alarms due to relatively common sources of carbon monoxide such as cigarette smoke.

In one embodiment, the detector 120 may be a biomimetic (chem-optical or gel cell) sensor having a synthetic hemoglobin that darkens in the presence of carbon monoxide, and lightens without the presence of carbon monoxide. Changes in the color of the sensor may be detected by a light sensor that activates the motor 112 to open the door 104 when a predetermined level of carbon monoxide is detected.

In another embodiment, the detector 120 may include a fuel cell that produces a current related to the concentration of carbon monoxide in the atmosphere. When the predetermined level of carbon monoxide is detected a corresponding current is produced by the fuel cell. A current corresponding to the predetermined level of carbon monoxide is configured to activate the motor 112 to open the door 104.

In another embodiment, the detector 120 includes a semiconductor on an insulating ceramic base to provide a sensor monitored by an integrated circuit. Oxygen increases a resistance of the semiconductor, while carbon monoxide reduces a resistance of the semiconductor. Accordingly a measurement of the resistance of the semiconductor is related to a concentration of carbon monoxide within in the enclosure 100. When a resistance related to the predetermined level of carbon monoxide is reached, the detector 120 activates the motor 112 to open the door 104.

Alternatively, the detector 120 may be any detector suitable for detecting any number of noxious gases. The detector 120 may be configured to detect multiple noxious gases. The detector 120 may be powered by the motor 112. Alternatively, the detector 120 may be powered by the control panel 114 or may be independently powered. The detector 120 may be battery operated or AC powered (with or without a battery backup). The detector 120 may be installed within the motor body 116 of the motor 112 during manufacture of the motor 112. In another embodiment, the detector 120 may be retro-fit into an existing motor 112. In the illustrated embodiment, a vent 122 is formed in the body 116. The vent 122 is positioned below the detector 120. The vent 122 enables noxious gases to pass therethrough so that the noxious gases are detectable by the detector 120.

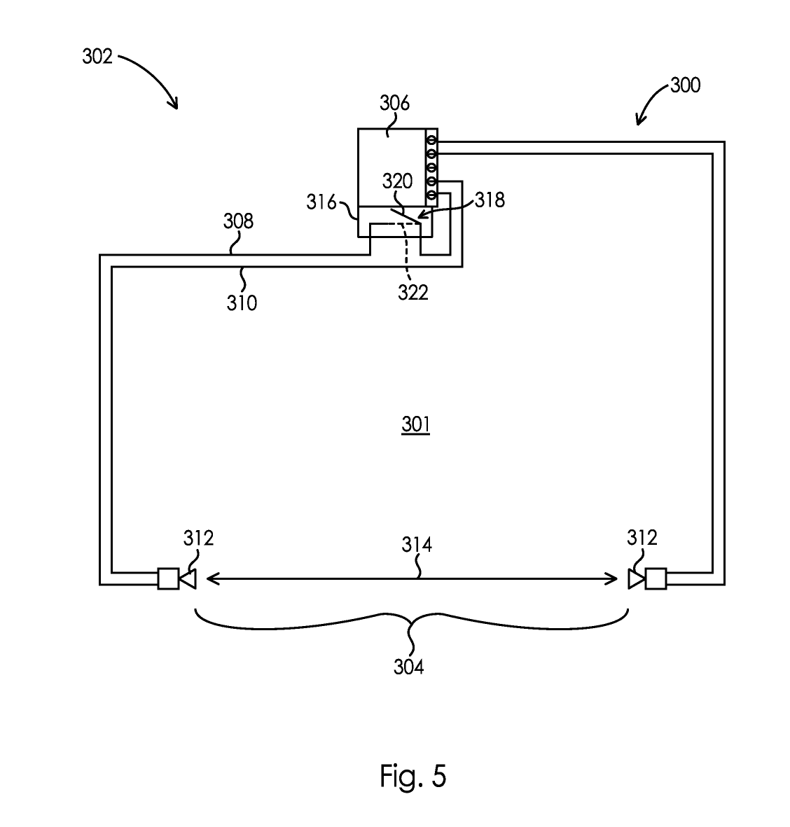

The detector 120 is in communication with a circuit 115 of the motor 112. The circuit 115 controls operation of the motor 112 to move the door 104 between the open position 106 and the closed position 108. The detector 120 may be wired to the circuit 115 or may communicate with the circuit 115 wirelessly. The detector 120 may communicate with the circuit 115 by sending a signal to the circuit 115 or by operating a switch within the circuit 115 that opens and closes a signal path within the circuit 115, as described in more detail with respect to FIG. 5.

During operation, the detector 120 monitors the environment of the enclosure 100. The detector 120 monitors for the presence of noxious gases within the enclosure 100. If a level of noxious gases reaches the predetermined level, the detector 120 is configured to activate the motor 112. The predetermined level of noxious gases may be determined based on a level of gases that may be harmful. If the predetermined level of noxious gases is neared or exceeded, the detector 120 activates the motor 112 so that the motor 112 moves the door 104 to the open position 106 (shown in FIG. 1). For example, the detector 120 may send a signal to the circuit 115 of the motor 112 instructing the motor 112 to move the door 104 to the open position 106. Alternatively, the detector 120 may break a signal path within the circuit 115 of the motor 112. When the signal path of the circuit 115 is broken, the motor 112 is configured to move the door 104 to the open position 106. When the door 104 is moved to the open position 106, the noxious gases are ventilated from the enclosure 100. Accordingly, the detector 120 prevents the build-up of noxious gases within the enclosure 100. In one embodiment, the door 104 remains in the open position 106 until the enclosure is inspected and cleared for further use. In another embodiment, the door 104 may be moved back to the closed position 108 (shown in FIG. 1) when the level of noxious gases detected by the detector 120 drops below the predetermined level. For example, the detector 120 may send a signal to the circuit 115 of the motor 112 instructing the motor 112 to move the door 104 back to the closed position 108. Alternatively, the detector 120 may close a signal path of the circuit 115 so that the door 104 is capable of being moved back to the closed position 108.

FIG. 3 is a front view of a control panel 114 formed in accordance with an embodiment. The control panel 114 is electrically or wirelessly coupled to the motor 112 (shown in FIG. 1) to control the motor 112. The control panel 114 includes a body 123 having at least one button 124. The button 124 activates the motor 112 to move the door 104 (shown in FIG. 1) between the open position 106 (shown in FIG. 1) and the closed position 108 (shown in FIG. 1). Other buttons 124 may be provided to activate the lighting devices 118 (shown in FIG. 2), to lock the door 104, or the like.

A detector 126 is installed internally within the body 123 of the control panel 114. The detector 126 may be a carbon monoxide detector, for example, a biomimetic detector, a fuel cell detector, or a semiconductor. Alternatively, the detector 126 may be any suitable detector for detecting any noxious gas. A vent 128 is positioned over the detector 126. Alternatively, the detector 126 may be coupled to the exterior of the control panel 114. The control panel 114 shown in FIG. 3 may be used with a motor 112 that includes the detector 120 (shown in FIG. 2). Alternatively, the safety system 102 may include only a motor 112 having the detector 120 or a control panel 114 having the detector 126. The detector 126 may be powered by the control panel 114 or may be powered independent from the control panel 114. The detector 126 may be battery operated or AC powered (with or without a battery backup). The detector 126 may be built into the control panel 114 during manufacturing. Alternatively, the detector 126 may be retrofit into an existing control panel 114.

The detector 126 is in communication with a circuit 125 of the control panel 114. The circuit 125 is configured to control operation of the control panel 114 to instruct the motor 112 to move the door 104 between the open position 106 and the closed position 108. The detector 126 may be wired to the circuit 125 or may communicate with the circuit 125 wirelessly. The detector 126 may communicate with the circuit 125 by sending a signal to the circuit 125 or by operating a switch within the circuit 125 that opens and closes a signal path within the circuit 125, as described in more detail with respect to FIG. 5.

The detector 126 operates similar to the detector 120. When the detector 126 detects a predetermined level of noxious gas, the detector 126 activates the motor 112. The detector 126 may directly activate the motor 112 or the detector 126 may activate the motor 112 through the control panel 114. The detector 126 activates the motor 122 to move the door 104 to the open position 106. For example, the detector 126 may send a signal to the circuit 125 of the control panel 114 instructing the control panel 114 to operate the motor 112 such that the door 104 is moved to the open position 106. Alternatively, the detector 126 may break a signal path within the circuit 125 of the control panel 114. When the signal path of the circuit 125 is broken, the control panel 114 is configured to operate the motor 112 to move the door 104 to the open position 106. In one embodiment, the detector 126 may activate the control panel 114 to instruct the motor 112 to move the door 104 to the closed position 108 when the level of noxious gases drops below the predetermined level.

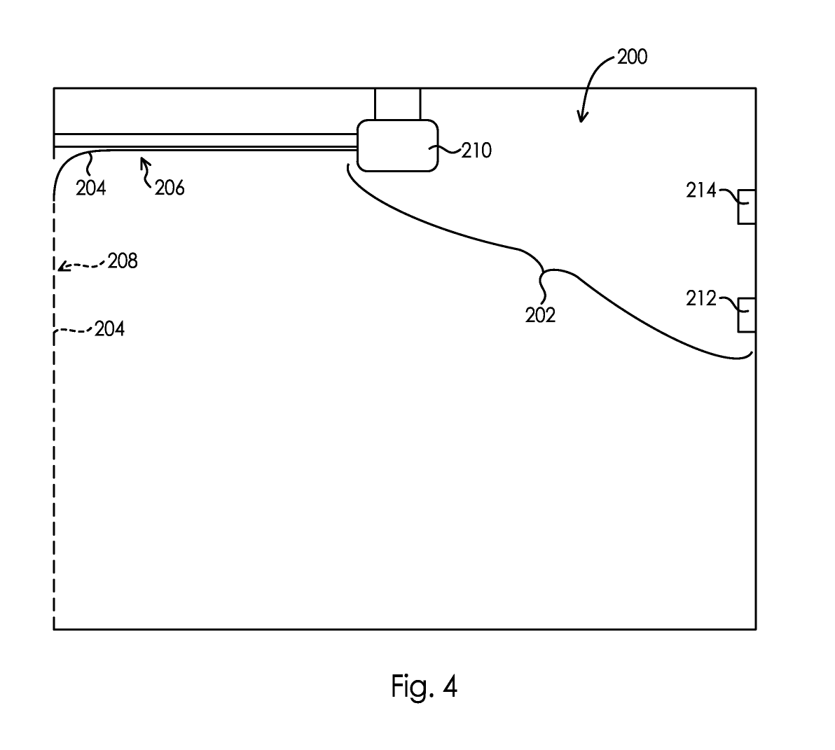

FIG. 4 is a schematic view of an enclosure 200 having a safety system 202 formed in accordance with another embodiment. The enclosure 200 includes a door 204 that is moved between an open position 206 and a closed position 208 (illustrated with dashed lines) by a motor 210. A control panel 212 is electrically or wirelessly coupled to the motor 210 to control an operation of the motor 210. A detector 214 is provided in communication with at least one of the motor 210 or the control panel 212. The detector 214 may be a carbon monoxide detector, for example, a biomimetic detector, a fuel cell detector, or a semiconductor. Alternatively, the detector 214 may be any suitable detector for detecting any noxious gas. The detector 214 may be positioned within any portion of the enclosure 200. For example, the detector 214 may be installed near a storage area for chemicals or the like. In the illustrated embodiment, the detector 214 is independently powered and wirelessly communicates with at least one of the motor 210 or the control panel 212. Alternatively, the detector 214 may be powered by one of the motor 210 or the control panel 212. The detector 214 may be battery operated or AC powered (with or without a battery backup). The detector 214 may also be wired directly to one of the motor 210 or the control panel 212.

The detector 214 is in communication with at least one of a circuit of the motor 210 or a circuit of the control panel 212. The circuit controls operation of the motor 210 to move the door 204 between the open position 206 and the closed position 208. The detector 214 may be wired to the circuit or may communicate with the circuit wirelessly. The detector 214 may communicate with the circuit by sending a signal to the circuit or by operating a switch within the circuit that opens and closes a signal path within the circuit, as described in more detail with respect to FIG. 5.

When the detector 214 detects a level of noxious gases that exceeds the predetermined level, the detector 214 activates the motor 210 to move the door 204 into the open position 206. The detector 214 may communicate directly with the motor 210 or may communicate with the motor 210 via the control panel 212. The detector 214 may send a signal to the circuit of the control panel 212 or the motor 210 to operate the motor 210 such that the door 204 is moved to the open position 206. Alternatively, the detector 214 may break a signal path within the circuit of the control panel 212 or the motor 210. When the signal path of the circuit is broken, the motor 210 moves the door 204 to the open position 206. In one embodiment, the detector 214 may instruct the motor 210 to move the door 204 to the closed position 208 when the level of noxious gases drops below the predetermined level.

FIG. 5 is a diagram of a circuit 300 of a safety system 302 formed in accordance with an embodiment. The safety system 302 is positioned within an enclosure 301 having an opening 304. A door (not shown) moves between an open position (as illustrated), wherein the opening 304 is opened, and a closed position (not shown), wherein the opening 304 is sealed. The circuit 300 includes a door opener 306. The door opener 306 may be a motor, for example, the motor 112 (shown in FIG. 2) or a control panel, for example, the control panel 114 (shown in FIG. 3). Alternatively, the door opener 306 may be a combination of a motor and a control panel. A first signal path 308 and a second signal path 310 extend from the door opener 306. In one embodiment, the circuit 300 may include any number of signal paths. Either the first signal path 308 or the second signal path 310 may be a positive signal path. The other of the first signal path 308 and the second signal path 310 may be a negative signal path. The first signal path 308 and the second signal path 310 extend to optical sensors 312 that direct an optical beam 314 across the opening 304. If the optical beam 314 is broken, the circuit 300 is broken. When the circuit 300 is broken, the door opener 306 moves the door into the open position.

The first signal path 308 extends through a detector 316 that is configured to detect noxious gases. The detector 316 includes a switch 318 that moves between an open position 320 and a closed position 322 (illustrated with dashed lines). In the closed position 322, the circuit 300 is complete so that the safety system 302 functions in a normal mode. In the open position 320, the circuit 300 is broken so that the door is moved to the open position. When the detector 316 detects a level of noxious gases that exceeds the predetermined level, the detector 316 opens the switch 318 to the open position 320 to break the circuit 300. When the circuit 300 is broken, the door is moved to the open position to ventilate the noxious gas from the enclosure 301. In one embodiment, the detector 316 may close the switch 318 after the level of noxious gas drops below the predetermined level. When the switch 318 is closed, the safety system 302 returns to the normal operating mode.

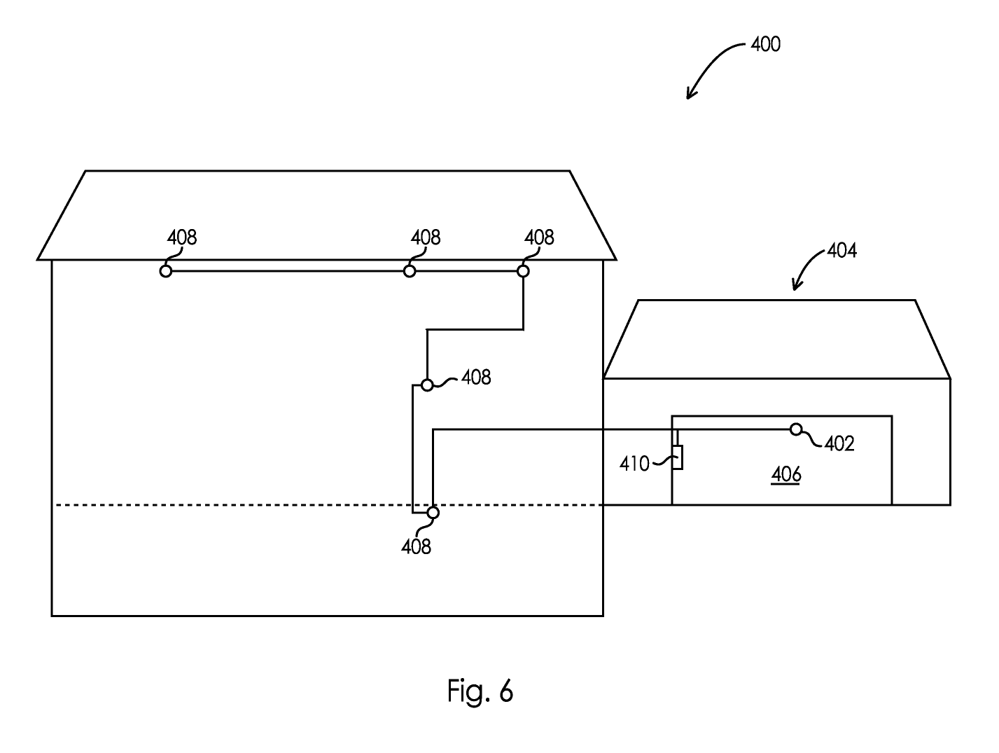

FIG. 6 is a schematic view of a building 400 having a safety system 402 formed in accordance with an embodiment and installed in an enclosure 404 associated with the building 400. The safety system 402 includes a motor, a control panel, and a detector (not shown) configured to operate in accordance with at least one of the embodiments described above to move a door 406 to an open position when a predetermined level of noxious gas in detected. In the illustrated embodiment, the enclosure 404 is attached to the building 400, for example, a residential building or a manufacturing, industrial, or commercial facility. Alternatively, the enclosure 404 may be detached from the building 400. For example, the enclosure 404 may be a detached garage for a residence. In another embodiment, the enclosure 404 may be a warehouse or the like and the building 400 may be an office or the like. In one embodiment, the enclosure 404 may be positioned remotely from the building 400. For example, the enclosure 404 may be a warehouse at a first location and the building 400 may be an office at a second location.

The building 400 includes an alert system 408 to provide a visual or audible alert that the predetermined level of noxious gas has been detected. The alert system 408 is positioned outside of the enclosure 404. The alert system 408 may be an existing smoke detector system, security system, or lighting system. The alert system 408 is activated when the detector of the safety system 402 detects the predetermined level of noxious gas. For example, the safety system 402 may activate a smoke detector system or an alarm system. In another example, the safety system 402 may flash the lights of a lighting system. In one embodiment, the alert system 408 notifies emergency agencies of the presence of noxious gas. Such notification may be performed through a security system. Alternatively, the safety system 402 may include a communication device 410 within the enclosure 404. In another embodiment, the communication device 410 may be positioned within the building 400 or elsewhere. The communication device 410 may communicate directly with emergency agencies. In one embodiment, the alert system 408 may operate through a power line, a phone line, a cable line, a local area network, a wide area network, the internet, an Ethernet cable, a modem or the like. In such an embodiment, the safety system 402 may send an alert via a telephone call or a display on a television, computer, or the like. In one embodiment, the safety system 402 may activate multiple alert systems 408.

The alert system 408 is illustrated as being wired directly to the safety system 402. Alternatively, the safety system 402 may communicate wirelessly with the alert system 408 through the communication device 410. In one embodiment, the safety system 402 and the alert system 408 may communicate over phone lines, power lines, cable lines, the internet, an Ethernet cable, a local area network, a wide area network, or the like. The alert system 408 may be installed with the safety system 402. Optionally, the safety system 402 may be retrofit to communicate with existing alert systems 408.

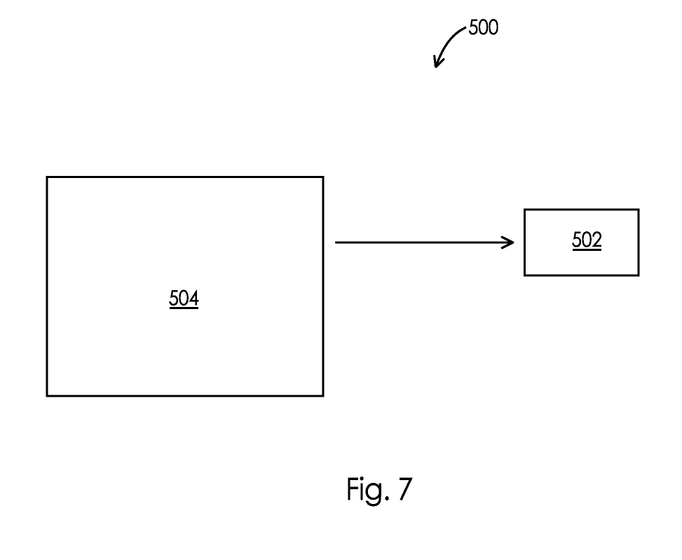

FIG. 7 is a schematic diagram of a safety system 500 formed in accordance with an embodiment and having a remote alert system 502 formed in accordance with an embodiment. The safety system 500 may be positioned in an enclosure 504 as described above. The enclosure 504 may be a warehouse, an office, home garage, or the like. For example, the enclosure 504 may be the home garage of an elderly or handicapped family member. The remote alert system 502 may be an alert system within the home of a family member or business owner. The remote alert system 502 may be any of the alert systems 408 described in FIG. 6. Alternatively, the remote alert system 502 may be an independent monitor or pocket sized alarm that may be configured to attach to a key chain or the like.

The safety system 500 remotely communicates with the remote alert system 502. For example, the safety system 500 may communicate with the remote alert system 502 through radio-frequency signals, satellite signals, or the like. Optionally, the safety system 500 may communicate with the remote alert system 502 through phone lines, power lines, cable lines, the internet, a wide area network, or the like. The remote alert system 502 provides remote notification of the presence of noxious gas at the enclosure 504. The remote alert system 502 may be utilized to monitor a business and/or a family member or friend's home.

The various embodiments provide a security system that detects the presence of noxious gases in an enclosed space, for example a garage. The system operates a door of the enclosed space to move the door to an open position, thereby ventilating the noxious gases from the space. The system may include an alert system that notifies an individual or emergency agency of the presence of noxious gases.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the various embodiments of the invention without departing from their scope. While the dimensions and types of materials described herein are intended to define the parameters of the various embodiments of the invention, the embodiments are by no means limiting and are exemplary embodiments. Many other embodiments will be apparent to those of skill in the art upon reviewing the above description. The scope of the various embodiments of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments of the invention, including the best mode, and also to enable any person skilled in the art to practice the various embodiments of the invention, including making and using any devices or systems and performing any incorporated methods. The patentable scope of the various embodiments of the invention is defined by the claims, and may include other examples that occur to those skilled in the art. Such other examples are intended to be within the scope of the claims if the examples have structural elements that do not differ from the literal language of the claims, or if the examples include equivalent structural elements with insubstantial differences from the literal languages of the claims.

What is claimed is:

1. A noxious gas detector installed internally within at least one of a motor configured to move a door of an enclosure between an open position and a closed position or a control panel for operating the motor, the detector in communication with a circuit of at least one of the motor or the control panel, the detector configured to detect noxious gas within the enclosure, the detector configured to send a signal to the circuit to move the door into the open position when a predetermined level of noxious gas is exceeded.

2. The detector of claim 1, wherein the detector is a carbon monoxide detector.

3. The detector of claim 1, wherein the detector is in communication with an alert system within a building associated with the enclosure so that the alert system is activated when the predetermined level of noxious gas is exceeded.

4. The detector of claim 1, wherein the detector notifies an emergency agency when the predetermined level of noxious gas is exceeded.

5. The detector of claim 1, wherein the detector is capable of being retrofit with at least one of an existing motor or an existing control panel.

6. The detector of claim 1, wherein the detector is in communication with a remote alert system so that the remote alert system is activated when the predetermined level of noxious gas is exceeded.

7. The detector of claim 1, wherein the detector is in communication with a security system within a building associated with the enclosure so that the security system is activated when the predetermined level of noxious gas is exceeded.

8. A noxious gas detector in communication with at least one of a motor configured to move a door of an enclosure between an open position and a closed position or a control panel configured to operate the motor, the detector in communication with a circuit of at least one of the motor or the control panel, the detector configured to detect noxious gas within the enclosure, the detector configured to send a signal to the circuit to move the door into the open position when a predetermined level of noxious gas is exceeded, the detector in communication with an alert system positioned outside of the enclosure so that the alert system is activated when the predetermined level of noxious gas is exceeded.

9. The detector of claim 8, wherein the alert system is a smoke detector system within a building associated with the enclosure.

10. The detector of claim 8, wherein the alert system is a security system within a building associated with the enclosure.

11. The detector of claim 8, wherein the alert system is a lighting system within a building associated with the enclosure.

12. The detector of claim 8, wherein the alert system is remote from the enclosure.

13. The detector of claim 8, wherein the alert system notifies an emergency agency when the predetermined level of noxious gas is exceeded.

14. The detector of claim 8, wherein the detector is capable of being retrofit with at least one of an existing motor or an existing control panel.

15. The detector of claim 8, wherein the detector is a carbon monoxide detector.

16. A circuit for operating a door comprising:
a signal path in communication with a door opener configured to move a door of an enclosure between an open position and a closed position, wherein the door opener is configured to move the door to the open position if the signal path is broken; and
a detector for detecting noxious gas within the enclosure, the detector configured to break the signal path when a predetermined level of noxious gas is exceeded so that the door moves to the open position.

17. The circuit of claim 16, wherein the detector includes a switch positioned within the signal path, the switch moveable between a closed position, wherein the signal path is complete, and an open position, wherein the signal path is broken, the switch moved to the open position when the predetermined level of noxious gas is exceeded.

18. The circuit of claim 16 further comprising an alert system that is activated when the signal path is broken.

19. The circuit of claim 16 further comprising optical sensors that transmit an optical beam across an opening of the door, the door moved to the open position if the optical beam is broken.

20. The circuit of claim 16, wherein the detector is capable of being retrofit into an existing circuit.
